(19) United States
(12) Patent Application Publication
(10) Pub. No.: US 2022/0188814 A1
(43) Pub. Date: Jun. 16, 2022

(54) APPENDING LOCAL CONTEXTUAL INFORMATION TO A RECORD OF A REMOTELY GENERATED RECORD LOG

(71) Applicant: Capital One Services, LLC, McLean, VA (US)

(72) Inventors: Brice ELDER, Mishawaka, IN (US); Julie MURAKAMI, New York, NY (US); Aditya PAI, San Francisco, CA (US)

(21) Appl. No.: 17/247,560

(22) Filed: Dec. 16, 2020

(51) Int. Cl. G06Q 20/38; G06Q 20/20; G06Q 20/40; G06F 9/451

(52) U.S. Cl. CPC G06Q 20/389; G06F 9/451; G06Q 20/4015; G06Q 20/204

(57) ABSTRACT

In some implementations, a device may receive, via an application, a record log associated with an account that is registered to the device. The device may determine that a user interface of the application is presenting the record log on a display of the device. The device may obtain record metadata that identifies a characteristic of a record of the record log. The device may analyze a local data structure of the device to identify image data associated with an event involving the record. The device may determine that the record is associated with the event based on the characteristic and image metadata associated with the image data, wherein the image metadata is stored in the local data structure in association with the image data. The device may cause the user interface to present, in association with the record, an image associated with the image data on the display.

### BACKGROUND

A device may receive record data of a record log using a computer network. The record log may be managed and/or maintained by a remote system from the device, such as a record log generator. The device may receive, from the remote system, the record data as records of the record log and/or may display the record log via a user interface of the display.

### SUMMARY

In some implementations, a device for appending information to one or more records includes a display; one or more memories that store a local data structure; and one or more processors, communicatively coupled to the one or more memories, configured to: receive, via an application executing on the device, a record log associated with an account that is registered to the application, wherein the record log is generated remotely from the device and includes records and respective metadata associated with one or more of the records; detect that the application is presenting, via a user interface, a record of the record log on the display; determine, from record metadata of the record, a characteristic of the record of the record log, wherein the characteristic includes at least one of a time associated with the record or a location associated with the record; determine that image data, stored in the local data structure, is associated with the record based on the characteristic and image metadata associated with the image data; and cause, via the user interface, the application to output an image in association with the record, wherein the image is based on the image data and provides context associated with the record.

In some implementations, a method for appending information to one or more records includes receiving, by a device and via an application, a record log associated with an account that is registered to the device; determining, by the device, that a user interface of the application is presenting the record log on a display of the device; obtaining, by the device, record metadata that identifies a characteristic of a record of the record log; analyzing, by the device based on the record metadata, a local data structure of the device to identify image data associated with an event involving the record; determining, by the device, that the record is associated with the event based on the characteristic and image metadata associated with the image data, wherein the image metadata is stored in the local data structure in association with the image data; and causing, by the device, the user interface to present, in association with the record, an image associated with the image data on the display.

In some implementations, a non-transitory computer-readable medium storing a set of instructions includes one or more instructions that, when executed by one or more processors of a device, cause the device to: receive a record log associated with an account, wherein the record log is received from a backend system associated with managing the account; obtain record metadata that identifies a characteristic of a record of the record log; determine, based on the characteristic, that the record is associated with image data stored in a local data structure of the device; and present, when the record is being presented via a user interface of the device, an image, in association with the record on a display of the user interface, wherein the image is associated with the image data.

### BRIEF DESCRIPTION OF THE DRAWINGS

FIGS. 1A-1C are diagrams of an example implementation relating to appending local contextual information to a record of a remotely generated record log.

FIG. 2 is a diagram of an example environment in which systems and/or methods described herein may be implemented.

FIG. 3 is a diagram of example components of one or more devices of FIG. 2.

FIG. 4 is a flowchart of an example process relating to appending local contextual information to a record of a remotely generated record log.

### DETAILED DESCRIPTION

The following detailed description of example implementations refers to the accompanying drawings. The same reference numbers in different drawings may identify the same or similar elements.

Various applications may utilize records and/or a record log (e.g., a collection of records) to manage and/or provide information associated with sources of the records. For example, a record log may maintain records associated with events and/or actions involving an account associated with the record log. Further, a user may register an account with an application that is configured to maintain a record log for the user. An account management system of the application may manage the account via a record log of records associated with events or actions involving the user. For example, the user may access the record log to review information associated with the events and/or actions in the record. As a more specific example, a banking application may utilize a record log to maintain records of transactions (e.g., credits and/or debits of the account) involving an account registered to a user (e.g., a transaction account holder) of a banking institution or other type of financial institution. In such an example, the user, via the banking application, may review record logs corresponding to financial statements and/or transaction account activity. For example, the user may monitor balances and/or cash flow based on transactions performed using the account and/or may review the account for fraudulent activity, such as unauthorized use of the transaction account for a transaction.

A record of a record log may be generated for a transaction via the account management system, which is remote from a transaction terminal and/or a transaction device (e.g., a user device and/or a transaction card) that was used to engage in the transaction. Although the account management system may identify certain metadata associated with the transaction and/or may generate corresponding record metadata for a record, this metadata is typically limited to a time (or date) of the transaction, a location of the transaction, an amount of the transaction, and/or a merchant involved in the transaction. Typically, this metadata is received in connection with the transaction as transaction data that is received from a transaction terminal used to facilitate the transaction.

However, in some instances, a user may not recall the occurrence of a transaction when reviewing a record associated with the transaction. For example, the user may misremember engaging in an authorized transaction with a merchant. In these instances, the user may request a customer service representative and/or a fraud department representative to investigate the transaction, despite the transaction being authorized by the user. Accordingly, such an investigation may result in wasted computing resources (e.g., processing resources and/or memory resources) to search and/or review contextual information (e.g., evidence) of the transaction to identify circumstances for the transaction (e.g., whether the transaction was fraudulently performed by a fraudulent user or the transaction was properly performed by an authorized user). Some contextual information can be obtained from some transaction devices, such as, automated teller machines (ATMs) that utilize camera devices to capture an image of a user engaging in a transaction at the transaction device. Additionally, or alternatively, some merchants include camera devices (e.g., security cameras) that can be reviewed to provide additional context for a transaction.

However, this contextual information typically is not reviewed unless an indication of fraud has been identified or an accusation of fraud has been made (e.g., to avoid wasting resources to investigate mostly non-fraudulent transactions and/or to maintain privacy of customers and/or merchants). Furthermore, certain transaction terminals and/or merchants do not utilize cameras, thereby preventing an ability to obtain that type of contextual information for transactions involving those types of transaction terminals and/or those merchants. Furthermore, by making such a request based on misremembering that the transaction was authorized, the user may consume and/or waste computing resources of a user device (e.g., a mobile phone and/or a computer) and/or consumable resources (e.g., fuel) to request a review of the transaction in person at a branch of the financial institution.

A user device associated with the user may include some contextual information that can be provided as a reminder to a user. For example, the user may have captured images in association with an event involving the transaction. However, typically, a user device is not configured to identify context information associated with a transaction or determine that images locally stored in the user device are associated with a transaction.

Some implementations described herein permit a device (e.g., a user device) to proactively append contextual information, such as an image, associated with a transaction (or other type of event or action) to a record of a record log that is associated with the event or transaction. For example, based on record metadata that identifies a time and/or place of a transaction and image metadata that identifies a time and/or place that image data for the image was captured, the device may determine that the image is associated with the transaction of the record. The image may have been locally captured by a camera of the device during a time period and/or at a location (or within a threshold distance of a location) associated with the transaction. For example, a user may capture a group photo during a dining experience at a restaurant and charge an account of the user for the dining experience, resulting in a transaction record for the dining experience being added to the transaction log. Upon the user reviewing the record log, as described herein, the group photo may be proactively appended to the record for the transaction and provided on a display of the device in association with the record to proactively provide additional context for the transaction. Proactively providing the contextual information (or proactively requesting a user to view contextual information associated with the transaction) would reduce the likelihood that the user misremembers the transaction occurring or that the transaction was authorized by the user, thereby reducing wasted resource for false reports of the transaction being fraudulent.

In this way, contextual information captured separately from an execution of a transaction may be proactively displayed (without a fraud investigation being prompted), via a device, in association with a record when a user is accessing and/or interacting with a record log. While images from transaction terminals or merchants may be proactively obtained for any or all transactions to proactively provide context for a transaction, such images may need to be processed to verify that the user is associated with the transaction (e.g., in consideration of privacy of bystanders in the images).

Accordingly, a device and/or an account management system, as described herein, may avoid consuming resources (e.g., computing resources and/or network resources) associated with obtaining contextual information (e.g., images of cameras which may or may not have captured images of users) from transaction terminals or merchants and/or processing the contextual information to verify that the contextual information is associated with the user. Furthermore, some implementations described herein permit the device to provide additional context for a transaction that involved a transaction terminal and/or merchant that did not utilize camera devices, thereby increasing the availability of providing context for a transaction.

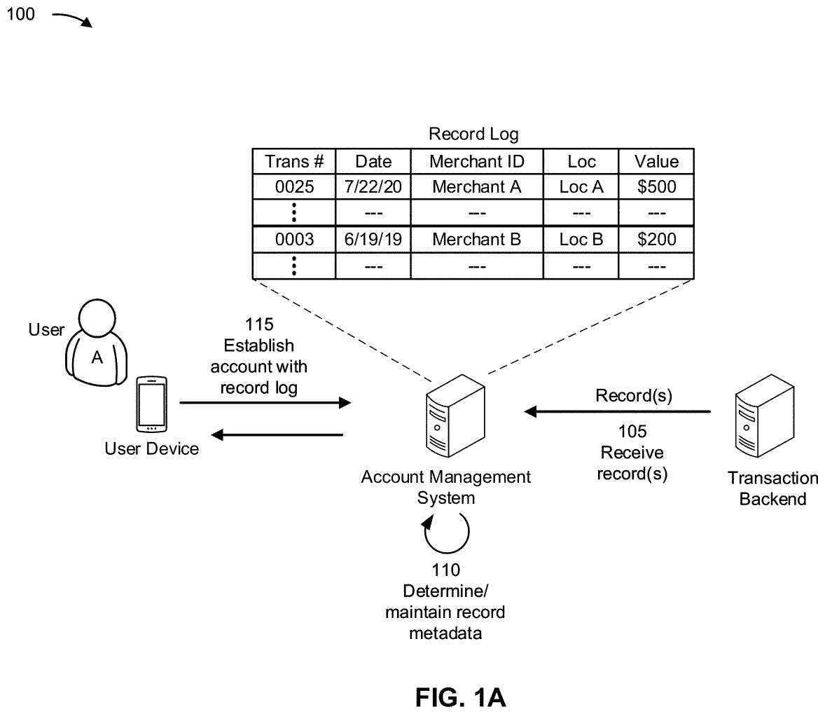

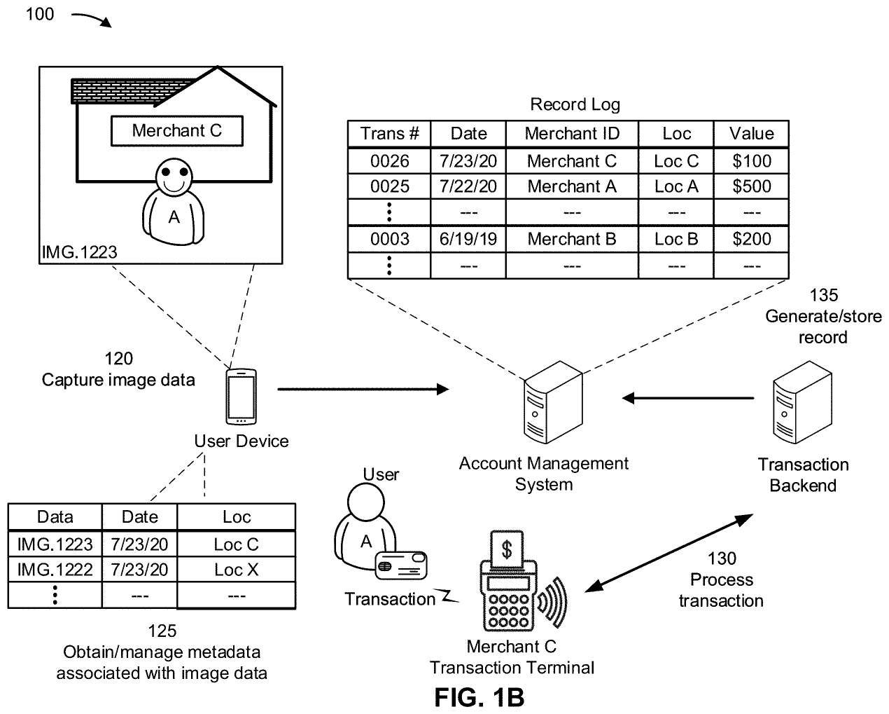

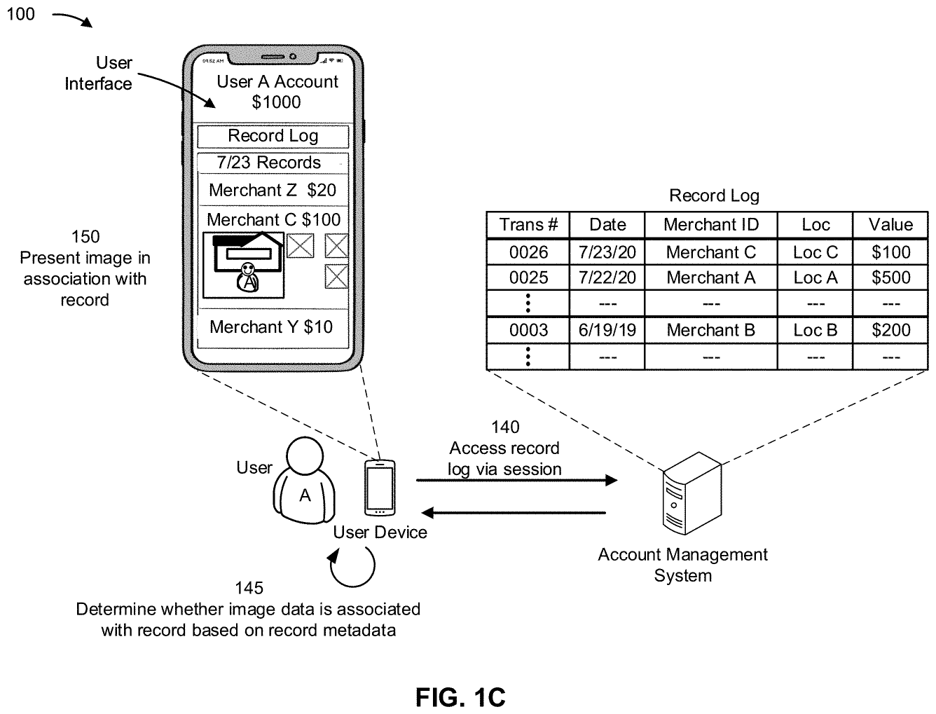

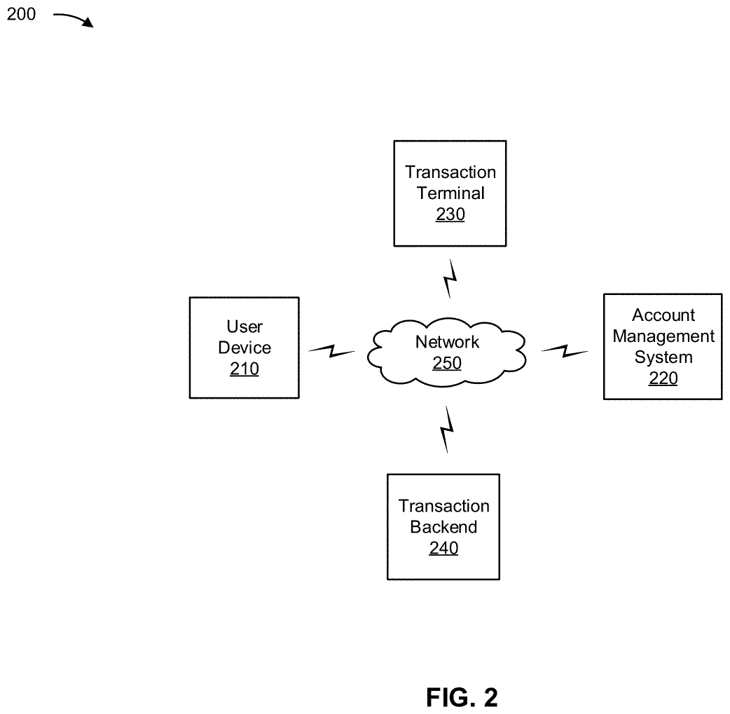

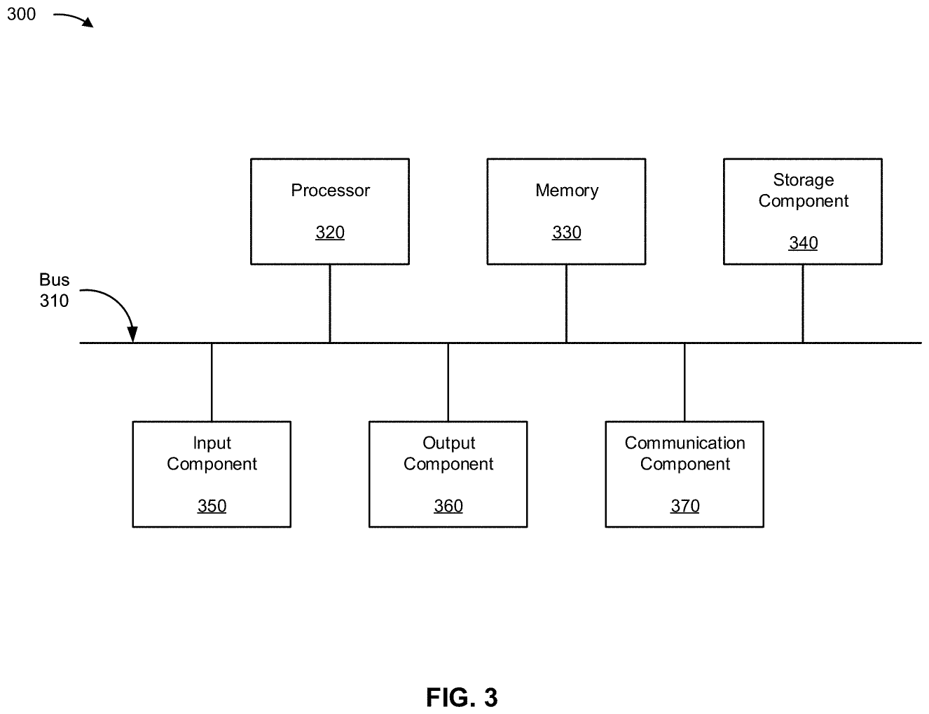

FIGS. 1A-1C are diagrams of an example implementation 100 associated with appending local contextual information to a record of a remotely generated record log. As shown in FIGS. 1A-1C, example implementation 100 includes a user device, an account management system, a transaction backend, and a transaction terminal. These devices are described in more detail below in connection with FIG. 2 and FIG. 3. Although example 100 is described in connection with a transaction account and/or records associated with transactions, other examples are possible, such as examples associated with managing records of an event management account (e.g., a calendar or schedule), an action management account (e.g., for managing a project and/or household), or any other suitable account that can be managed by a similar system as the account management system described herein (or a similar application that is associated with the account management system).

As shown in FIG. 1A, and by reference number 105, the account management system may receive records from a transaction backend. For example, the account management system may receive the records based on one or more transactions associated with the records being executed via the transaction backend and/or a transaction terminal, as described elsewhere herein.

A record may include and/or correspond to an entry associated with a transaction involving a merchant and/or a user associated with the user device (shown and referred to herein as “User A”). For example, the record may include record information that is associated with (or unique to) the transaction, such as a record identifier, a transaction value (e.g., corresponding to an amount of a payment or purchase and/or an amount of a credit or debit), a merchant identifier, a merchant type identifier or merchant category identifier, a date of the transaction, a time of the transaction, and/or a location of the transaction.

As further shown in FIG. 1A, and by reference number 110, the account management system may determine and/or maintains record metadata associated with the records. For example, based on the record information identified or extracted from the record, the account management system may determine and/or obtain record metadata associated with the record and/or the transaction. More specifically, the account management system may implement a preprocessing technique to determine and/or identify (e.g., using a model, such as a record processing model, a transaction processing model, a machine learning model and/or a natural language processing model) the record metadata from machine generated data that is used to represent the record information. Accordingly, the account management system may obtain record data associated with the record.

The record metadata may indicate a characteristic of the record and/or the transaction associated with the record. For example, the characteristic may include a time (e.g., a time that the transaction was executed and/or a time that the record was generated) and/or a location (e.g., a location of a merchant involved in the transaction) associated with the transaction and/or associated with the transaction being executed. Accordingly, the account management system may determine a time, a location, and/or a merchant associated with the record to permit the account management system to provide information identifying the time, the location, and/or the merchant to the user device, as described elsewhere herein.

As further shown in FIG. 1A, and by reference number 115, the user device may establish an account that is managed by the account management system. For example, a user (shown as and referred to herein as “User A”) may register the account with the account management system based on the user having a transaction account (e.g., a checking account, a credit account, and/or a savings account) with a financial institution associated with the account management system. User A may register the account via an application that is installed and executing on the user device and that is associated with the account management system. The account management system may serve as a backend system of the application.

In some implementations, the account corresponds to a transaction account. In such a case, the record log may correspond to a transaction log of the transaction account, and the record may correspond to an entry of the transaction log that logs (or maintains) a transaction of the transaction account and the characteristic.

In some implementations, prior to establishing the account and/or accessing the record log, the user device, via a user interface of the application or the user device, may prompt User A to perform a verification and/or authentication process. For example, the user device may request User A to provide feedback indicating that User A is an authorized user of the account. More specifically, the feedback may include a user credential and/or a user input associated with a biometric analysis (e.g., a fingerprint scan, an image of User A's face, and/or audio produced by User A's voice). Additionally, or alternatively, the feedback may be associated with a multi-factor authentication of User A.

Additionally, or alternatively, in association with the verification or authentication process, the user device may prompt or request User A to provide feedback that includes authorization for the application to access a local data structure (e.g., a photo library and/or a contextual information database) stored in a memory of the user device. In response to the prompt, the user device may receive a user input that authorizes the application to access a component of the user device, such as a local data structure (e.g., that stores images and/or image data associated with the user device) and/or a camera of the user device (e.g., for a particular amount of time). In some implementations, the user device or the application may prompt a user to permit access to the local data structure each time the application is to analyze one or more images and/or metadata of the images stored in the local data structure. In this way, the application may improve security by prompting or requesting User A to authorize the application and/or the user device to present an image in association with a record on the display of the user device to provide context for a transaction represented by the record.

To maintain privacy of User A, the application and/or the user device may ensure that the user opts in (e.g., via an authorization and/or authentication of the user) to enable access to the local data structure of the user device. Accordingly, the account management system may be configured to abide by any and all applicable laws with respect to maintaining the privacy of User A and/or content of User A's user device. In some implementations, the account management system may not download (or permanently store) any image data or other contextual information stored in the local data structure. Additionally, or alternatively, the user device may anonymize and/or encrypt any private information associated with User A and/or accounts, messages, images, audio, and/or the like of User A that may be stored in the local data structure. In some implementations, the local data structure may include an index associated with a cloud storage device and/or pointers to a remote data structure (e.g., a cloud-based data structure, such a photo album or shared album in a cloud storage device).

In some implementations, the application of the user device may have or may be configured to have limited access to the local data structure. For example, the application may be configured to only have access to the transaction account periodically and for a threshold time period (e.g., a time period associated with the transaction), to only have access to a limited number of most recently posted transactions (e.g., the last ten transactions, twenty transactions, and/or the like), to only have access to a subset of data in the local data structure, to only have access to a limited number of most recently generated images (e.g., the most recent 100 images captured by the user device), and/or to only have access to a subset of data that was captured within a threshold distance associated with a particular record. According to some implementations, the user may specify which contextual information and/or which types of contextual information that the application may have access to and/or that the application may receive. Accordingly, User A may provide authorization for the application and/or the user device to perform a look-up operation of a local data structure (e.g., based on a characteristic of a record).

As shown in FIG. 1B, and by reference number 120, the user device may capture image data. For example, using a camera device and/or a camera application of the user device, User A may capture an image of User A in the presence of a merchant, shown as and referred to herein as “Merchant C”, or while being a patron of Merchant C. The image is identified by an image identifier IMG.1223. The user device may store the image and/or image data associated with the image in the local data structure in an entry that that includes the image identifier. In some implementations, the image may be remotely stored (e.g., in a cloud-based storage), and image data may include data that points to the remotely stored image.

As further shown in FIG. 1B, and by reference number 125, the user device may obtain and/or manage metadata associated with the image data. For example, based on capturing the image (or other contextual information associated with the transaction, such as audio or video), the user device may determine a time at which the image was captured and/or may store a corresponding timestamp in the local data structure as image metadata of the image. Additionally, or alternatively, the user device, based on the camera device capturing the image, may determine and/or store location information associated with a location of the user device when the image was captured (e.g., using a global positioning system (GPS) component of the user device). The user device may store the location information in the local data structure as image metadata of the image (e.g., with an entry identified by IMG.1223 and/or that includes a timestamp of the image).

As further shown in FIG. 1B, and by reference number 130, the transaction terminal and/or the transaction backend may process a transaction. For example, User A may engage in a transaction with Merchant C using the transaction terminal and a transaction device, such as the user device and/or a transaction card (e.g., a credit card, a debit card, and/or a loyalty card). The transaction may involve payment for a service provided by Merchant C or a purchase of a product sold by Merchant C.

As further shown in FIG. 1B, and by reference number 135, the transaction backend causes the account management system to generate and/or store a record associated with the transaction. For example, based on executing the transaction between User A and Merchant C, the transaction backend causes the account management system to generate a record (identified by transaction number “0026” in FIG. 1B) in the record log associated with User A's account. The record identifies a date of the transaction (“7/23/20”), a merchant ID of Merchant C (“Merchant C”), a location of the transaction (“Loc C”), and a value of the transaction (“$100”). Additionally, or alternatively, the record log may include timing associated with the transaction, as determined or identified by the account management system based on transaction information received from the transaction backend. Accordingly, the record log is generated remotely from the user device and/or based on information from devices or systems other than the user device.

As shown in FIG. 1C, and by reference number 140, the user device may access the record log via a session. For example, the session may involve the application being opened (e.g., by User A and/or in association with a verification process to authenticate User A) and/or executing on the user device. During the session, the user device may receive, via the application, the record log (e.g., based on the record log being associated with User A's account, which is registered to the application). For example, based on a user input to open the record log, the user device may submit a request to the account management system to provide the record log and/or stream (e.g., as a backend system of the application) records of the record log to the user device.

In some implementations, during the session, the user device and/or the application may monitor which records of the record log are being displayed and/or which records in the record log are likely to be displayed (e.g., based on one or more other records being displayed that are within a threshold quantity of records from one or more record logs that are actively being presented on the display of the user device). As described elsewhere herein, based on the record log being displayed and/or a record associated with the transaction between User A and Merchant C (referred to herein as the “Merchant C record”) being displayed, the user device may determine whether the local data structure includes any images that may proactively provide context of the transaction in association with the record.

As further shown in FIG. 1C, and by reference number 145, the user device may determine whether image data is associated with a record based on the record metadata. For example, based on obtaining or identifying record metadata that identifies a time associated with the Merchant C record, the application and/or the user device may look up a time period associated with the time (e.g., within ten minutes, thirty minutes, one hour or more of the time of the Merchant C record) to identify whether any images were captured during that time period (indicating that the images are related to the transaction). Additionally, or alternatively, the application and/or the user device may look up an area associated with a location associated with the Merchant C record (e.g., an area that is defined as within a threshold distance of the location, a geographic region of the location, or the like) to identify whether any images were captured within the area (indicating that the images are related to the transaction).

In some implementations, the user device may determine a location of Merchant C (e.g., using a geographical mapping system and/or a geographical navigation system). The location of Merchant C may correspond to an address of Merchant C, geographical coordinates of Merchant C, a jurisdiction of Merchant C, and/or a region of Merchant C.

In some implementations, the application and/or user device may determine whether to identify (e.g., search for) an image associated with a record based on whether the record is actively being presented on the display of the user device (e.g., during the session). For example, the user device may determine which records are actively being displayed and perform a lookup operation of the local data structure to determine whether an image is associated with the records. In this way, the user device may conserve resources by only identifying images for records that are most relevant or most likely to be presented and avoiding wasting resources by identifying an image associated with a record that may ultimately never be presented on the display of the user device. Additionally, or alternatively, to avoid delays in identifying and/or processing images, the user device may determine that a set of records are likely to be displayed based on a determination that one or more other records of the record log are being presented on the display (e.g., because a user is likely to scroll to the set of records because the set of records is within a threshold quantity of the records that are being presented on the display). In this way, the user device may present images and/or provide context for a record with reduced latency, relative to waiting to determine that the records are actively being displayed.

In some implementations, when the user device determines that an image is associated with a record log that is being presented on the display, the user device, via the application, may prompt User A (e.g., in real-time) to authorize access to the image and/or presentation of the image in association with the record to provide context for the record. Accordingly, based on feedback from User A authorizing presentation of the image in association with the record log, the image may be presented, as shown, to provide context of the transaction to User A (e.g., to remind User A that User A was at Merchant C during the transaction). Accordingly, based on identifying a merchant location of the transaction, the user device may perform a lookup of the local data structure based on a geographical area associate with the location of Merchant C. Based on image IMG.1223 having metadata that identifies Loc_C (and/or Loc_C being within a threshold distance of the location of Merchant C), the user device may determine that the image can provide context for the transaction to User A.

Accordingly, the user device, via the application, may analyze, based on the record metadata, a local data structure of the device to identify image data associated with a transaction or event involving the record. In this way, without having to process or analyze the images (e.g., using an image processing technique and/or a facial recognition technique to identify User A), the user device may determine that an image is associated with the transaction based on a comparison and/or similarity between the record metadata of the record and the image data of the image.

In some implementations, the user device may process the images to identify contextual information associated with the transaction. For example, the user device may include an image processing model (e.g., an object detection model, an object identification model, optical character recognition model, and/or a computer vision model) to identify contextual content depicted in the image. More specifically, based on the processing the image, the user device may identify that a sign in the image says “Merchant C.” In such a case, the user device may determine and/or verify that the image is associated with a transaction involving Merchant C.

In some implementations, the user device may process one or more images to identify objects or items that are associated with a particular transaction. For example, when shopping at Merchant C and/or after shopping at Merchant C, User A may capture images of products and/or scan barcodes of products that are known to be available at the Merchant C location (e.g., based on a merchant type identifier of Merchant C). Accordingly, the user device may determine and/or verify that the transaction is likely related to the product based on the image being captured with a same time period of the transaction and/or at a same location of the transaction. Additionally, or alternatively, the user device may compare pricing information that is depicted in an image. For example, if User A captures an image of a receipt associated with the transaction and/or a price tag of a product, the user device, using the image processing model, may determine and/or verify that the image is associated with the transaction based on a value of the transaction (e.g., based on a value of the receipt matching a value of the transaction and/or based on a value of a price tag being less than or equal to a value of the transaction). In some implementations, if the depicted value in the image is greater than a value of the transaction, the user device may determine that the image is not associated with the transaction.

As further shown in FIG. 1C, and by reference number 150, the user device presents the image in association with the record via a display of the user device. For example, as shown, the image may be embedded within a rendering of the Merchant C record to intuitively provide context for a transaction of the Merchant C record. In some implementations, the user device, via a graphical user interface (e.g., a graphical user interface used to present the record log), may cause the application to output the image in association with the record.

Additionally, or alternatively, the user device may provide the image to the account management system to permit the account management system to store the image as contextual data associated with the record. For example, based on receiving authorization to upload images that are determined to be associated with records (e.g., based on the record data and/or the image data as described elsewhere herein), the user device may provide the image to the account management system to permit other devices associated with User A to present the image to provide context for the record. More specifically, uploading an image to the account management system (e.g., as contextual metadata for the record) can permit the account management system to present the image via a display of another device and/or via a graphical user interface of a browser being used to access a website of the account management system. As another example, a primary user of an account (e.g., a guardian) may authorize images captured by a device of a secondary user of the account (e.g., a minor supported by the guardian) within a same time period of a transaction or within an area of the transaction to be uploaded to the account management system and/or provided to a device of the primary user (e.g., to verify that the transaction was performed by the secondary user rather than a fraudulent user).

In this way, the user device and/or account management system may permit a user to access contextual information associated with a record that was separately obtained and/or generated from the record. Accordingly, rather than the account management system monitoring a plurality of remotely located camera devices and/or processing images captured by the remotely located camera devices, the user device and/or the account management system, according to examples described herein, permit local contextual images to be identified and/or presented in association with a record to provide context for the record (e.g., based on a time, a location, a merchant, and/or content of an image). Therefore, the user device and/or the account management system, as described herein, may conserve computing resources, network resources, and/or hardware resources associated with obtaining contextual information and/or images that may be associated with a transaction and/or analyzing the contextual information, the images, and/or image metadata associated with the images to identify contextual information and/or images that are related to a record and proactively provide the related contextual information and/or images in association with records to provide context for the records.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

FIG. 2 is a diagram of an example environment 200 in which systems and/or methods described herein may be implemented. As shown in FIG. 2, environment 200 may include a user device 210, an account management system 220, a transaction terminal 230, a transaction backend 240, and a network 250. Devices of environment 200 may interconnect via wired connections, wireless connections, or a combination of wired and wireless connections.

The user device 210 includes one or more devices capable of receiving, generating, storing, processing, and/or providing information associated with appending local contextual information to a record of a remotely generated record log, as described elsewhere herein. The user device 210 may include a communication device and/or a computing device. For example, the user device 210 may include a wireless communication device, a mobile phone, a user equipment, a laptop computer, a tablet computer, a desktop computer, a set-top box, a wearable communication device (e.g., a smart wristwatch, a pair of smart eyeglasses, a head mounted display, or a virtual reality headset), or a similar type of device.

Account management system 220 includes one or more devices capable of receiving, generating, storing, processing, and/or providing record data and/or a record log associated with an account of a user and/or an account associated with user device 210, as described elsewhere herein. Account management system 220 may include a communication device and/or a computing device. For example, account management system 220 may include a server, such as an application server, a client server, a web server, a database server, a host server, a proxy server, a virtual server (e.g., executing on computing hardware), or a server in a cloud computing system. In some implementations, account management system 220 includes computing hardware used in a cloud computing environment.

The transaction terminal 230 includes one or more devices capable of facilitating an electronic transaction. For example, the transaction terminal 230 may include a point-of-sale (PoS) terminal, a payment terminal (e.g., a credit card terminal, a contactless payment terminal, a mobile credit card reader, or a chip reader), and/or an automated teller machine (ATM). The transaction terminal 230 may include one or more input components and/or one or more output components to facilitate obtaining data (e.g., account information) from a transaction device (e.g., a transaction card, a mobile device executing a payment application, or the like) and/or to facilitate interaction with and/or authorization from an owner or accountholder of the transaction device. Example input components of the transaction terminal 230 include a number keypad, a touchscreen, a magnetic stripe reader, a chip reader, and/or a radio frequency (RF) signal reader (e.g., a near-field communication (NFC) reader). Example output devices of transaction terminal 230 include a display and/or a speaker.

Transaction backend 240 includes one or more devices associated with a financial institution and/or a transaction card association that authorizes transactions and/or facilitates a transfer of funds or payments between an account managed by account management system 220. For example, transaction backend 240 may include one or more devices of one or more issuing banks associated with a cardholder associated with the account, one or more devices of one or more acquiring banks (or merchant banks) associated with transaction terminal 230, and/or one or more devices associated with one or more card associations (e.g., VISA® or MASTERCARD) associated with a transaction card of the account. Accordingly, in response to receiving transaction data from transaction terminal 230, various devices of financial institutions and/or card associations of transaction backend 240 may communicate to authorize the transaction and/or transfer funds between accounts associated with the cardholder and/or transaction terminal 230.

The network 250 includes one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to user device 210, account management system 220, transaction terminal 230, and/or transaction backend 240. In some implementations, user device 210, account management system 220, transaction terminal 230, and/or transaction backend 240 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a GPS component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

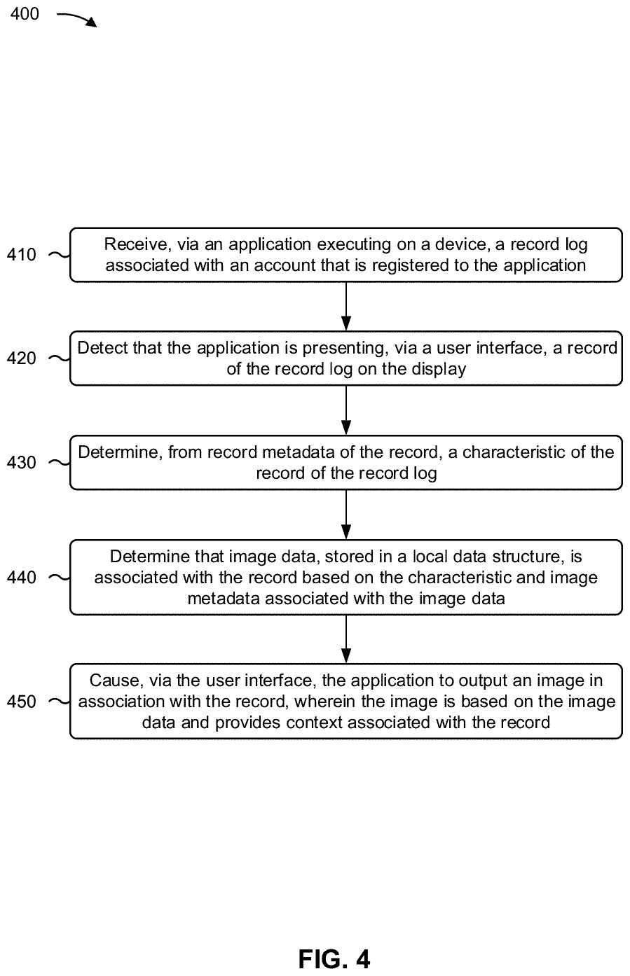

FIG. 4 is a flowchart of an example process 400 associated with appending local contextual information to a record of a remotely generated record log. In some implementations, one or more process blocks of FIG. 4 may be performed by a user device (e.g., user device 210). In some implementations, one or more process blocks of FIG. 4 may be performed by another device or a group of devices separate from or including the user device, such as an account management system (e.g., account management system 220). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving, via an application executing on the device, a record log associated with an account that is registered to the application (block 410). In some implementations, the record log is generated remotely from the device and includes records and respective metadata associated with one or more of the records. As further shown in FIG. 4, process 400 may include detecting that the application is presenting, via a user interface, a record of the record log on the display (block 420).

As further shown in FIG. 4, process 400 may include determining, from record metadata of the record, a characteristic of the record of the record log (block 430). In some implementations, the characteristic includes at least one of a time associated with the record or a location associated with the record. As further shown in FIG. 4, process 400 may include determining that image data, stored in the local data structure, is associated with the record based on the characteristic and image metadata associated with the image data (block 440). As further shown in FIG. 4, process 400 may include causing, via the user interface, the application to output an image in association with the record, wherein the image is based on the image data and provides context associated with the record (block 450).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device for appending information to one or more records, the device comprising:
a display;
one or more memories that store a local data structure; and
one or more processors, communicatively coupled to the one or more memories, configured to:
receive, via an application executing on the device, a record log associated with an account that is registered to the application, wherein the record log is generated remotely from the device and includes records and respective metadata associated with one or more of the records;
detect that the application is presenting, via a user interface, a record of the record log on the display;
determine, from record metadata of the record, a characteristic of the record of the record log, wherein the characteristic includes at least one of a time associated with the record or a location associated with the record;
determine that image data, stored in the local data structure, is associated with the record based on the characteristic and image metadata associated with the image data; and
cause, via the user interface, the application to output an image in association with the record, wherein the image is based on the image data and provides context associated with the record.

2. The device of claim 1, wherein the one or more processors are further configured to:
prior to determining that the image data is associated with the record, receive a user input that authorizes access to the local data structure to perform a look-up operation to identify the image data based on the characteristic; and
perform a verification process to verify that an authorized user of the account provided the user input,
wherein the local data structure is analyzed based on a result of the verification process.

3. The device of claim 1, wherein the one or more processors, when determining that the image data is associated with the record, are configured to:
identify data in the local data structure that has image metadata associated with the characteristic; and
determine that the image data is associated with the record based on at least one of:
the image metadata including a timestamp associated with capturing the image, or
the image metadata identifying a location of the device when the image was captured.

4. The device of claim 1, wherein the characteristic of the record is determined based on at least one of:
a determination that the record is being presented on the display, or
a determination that one or more other records of the record log are being presented on the display.

5. The device of claim 1, wherein the record log is received from a backend system, associated with the application, that remotely generated the record in association with the characteristic.

6. The device of claim 1, wherein the account comprises a transaction account, the record log comprises a transaction log of the transaction account, and the record comprises an entry of the transaction log that logs a transaction of the transaction account and the characteristic.

7. The device of claim 1, wherein the record comprises an entry associated with a transaction involving a merchant,
wherein the location corresponds to a location of the merchant, and
wherein the image metadata indicates that the image was captured at the location of the merchant.

8. A method for appending information to one or more records, comprising:
receiving, by a device and via an application, a record log associated with an account that is registered to the device;
determining, by the device, that a user interface of the application is presenting the record log on a display of the device;
obtaining, by the device, record metadata that identifies a characteristic of a record of the record log;
analyzing, by the device based on the record metadata, a local data structure of the device to identify image data associated with an event involving the record;
determining, by the device, that the record is associated with the event based on the characteristic and image metadata associated with the image data, wherein the image metadata is stored in the local data structure in association with the image data; and
causing, by the device, the user interface to present, in association with the record, an image associated with the image data on the display.

9. The method of claim 8, further comprising:
prior to analyzing the local data structure, receive a user input of the application that authorizes access to the local data structure to look up the image data; and
perform a verification process to verify that an authorized user of the account provided the user input,
wherein the local data structure is analyzed based on a result of the verification process.

10. The method of claim 8, further comprising:
prior to analyzing the local data structure, detect that the record is actively being presented on the display,
wherein the local data structure is analyzed to identify the image data based on detecting that the record is actively being presented on the display.

11. The method of claim 8, wherein the characteristic comprises at least one of:
a time associated with the record,
a location associated with the record, or
a merchant associated with the record.

12. The method of claim 8, wherein the characteristic includes a timestamp associated with the record, and
wherein the image metadata includes a timestamp that indicates a time at which the image data was generated by the device.

13. The method of claim 8, wherein the characteristic identifies a location associated with the record, and
wherein the image metadata identifies a location of the device that was annotated when the image data was captured.

14. The method of claim 8, wherein the record comprises an entry associated with a transaction involving a merchant,
wherein the image metadata indicates a location of the merchant and the image data includes image data captured at the location of the merchant.

15. A non-transitory computer-readable medium storing a set of instructions, the set of instructions comprising:
one or more instructions that, when executed by one or more processors of a device, cause the device to:
receive a record log associated with an account, wherein the record log is received from a backend system associated with managing the account;
obtain record metadata that identifies a characteristic of a record of the record log;
determine, based on the characteristic, that the record is associated with image data stored in a local data structure of the device; and
present, when the record is being presented via a user interface of the device, an image, in association with the record on a display of the user interface, wherein the image is associated with the image data.

16. The non-transitory computer-readable medium of claim 15, wherein the one or more processors are further configured to:
prior to determining that the record is associated with the image data, detect that the record log is being presented via the display,
wherein the local data structure is analyzed to identify the image data based on the record being presented on the display.

17. The non-transitory computer-readable medium of claim 15, wherein the one or more processors are further configured to:
prior to determining that the record is associated with the image data, prompt, via the user interface, a user to provide feedback associated with whether the image is to be presented,
wherein the local data structure is analyzed to identify the image data based on receiving feedback from the user that indicates that the image is to be presented.

18. The non-transitory computer-readable medium of claim 17, wherein the feedback from the user is received in association with a verification that the user is an authorized user of the account.

19. The non-transitory computer-readable medium of claim 15, wherein the one or more instructions, that cause the device to determine that the record is associated with the image data, cause the device to:
determine, based on the characteristic being a timestamp, a time period associated with when the record was generated;
perform a lookup of the local data structure based on the time period; and
identify that a timestamp of the image data indicates that the image was captured within the time period.

20. The non-transitory computer-readable medium of claim 15, wherein the one or more instructions, that cause the device to determine that the record is associated with the image data, cause the device to:
determine, based on the characteristic being a merchant location, a geographical area associated with a merchant involved in the record;
perform a lookup of the local data structure based on the geographical area; and
identify that image data identifies a location that indicates that the image was captured within the geographical area.
